(19) United States
(12) Patent Application Publication
(10) Pub. No.: US 2025/0174227 A1
(43) Pub. Date: May 29, 2025

(54) System and methods for automatically assisting users in conversations

(71) Applicant: Qnaptic, Inc., Palo Alto, CA (US)

(72) Inventors: Ashutosh Malaviya, San Jose, CA (US); Xin Wen, Sunnyvale, CA (US); Hallie Whitney Mass, San Jose, CA (US); Erik Weitzman, Redwood City, CA (US); Satish Menon, Sunnyvale, CA (US); Jeff Argast, Palo Alto, CA (US)

(73) Assignee: Qnaptic, Inc., Palo Alto, CA (US)

(21) Appl. No.: 18/518,974

(22) Filed: Nov. 25, 2023

(51) Int. Cl. G10L 15/197; G10L 13/02; G10L 15/06; G10L 15/22

(52) U.S. Cl. CPC G10L 15/197; G10L 13/02; G10L 15/063; G10L 15/22

(57) ABSTRACT

A computer system for assisting users to remember words during conversations includes a computer memory that stores stuck markers that indicate a user forgets a word in a conversation, wherein the computer memory stores a list of stuck words that the user often forgets during conversations. The processors can execute a conversation computation agent and a large language model responsive to the conversation computation agent. The conversation computation agent can receive a conversation conducted by the user, the conversation comprising a stuck episode in which the user forgets a word or a phrase, The large language model can detect the stuck episode in the conversation based on the stuck markers stored in the computer memory. The large language model can generate the word or the phrase forgotten by the user in the stuck episode based on the list of stuck words and the context in the conversation.

### BACKGROUND OF THE INVENTION

The present application relates to computer technologies for assisting users to retrieve memories, and in particular, to technologies that enable users to remember words during conversations.

Almost everyone has had the experience of forgetting certain words during conversations. People may forget words more frequently due to aging, lack of sleep, stress, or medical conditions such as Alzheimer, aphasia, and dementia. During a conversation, one person may forget the name of someone, a place, or an object and the conversation becomes stuck while the person tries to remember the word. For example, a person ordering a coffee from a barrister may forget the name of the person's favorite coffee while distressed by people waiting in line behind. The occurrences of stuck conversations are not only embarrassing to the speaker but can also inhibit the person's communications in daily and social lives.

Forgetting words and being stuck in a conversation are often alleviated by a friend or a family member who is familiar with the speaker's life experiences and daily routines. The speaker may convey certain information associated with the forgotten word to allow the companion to come up with the forgotten words in the speaker's mind.

There is a long-felt need for an automated tool that can assist a speaker to recall forgotten words in daily conversations when the speaker is not accompanied by a friend or a family member.

### SUMMARY OF THE INVENTION

The presently disclosed system and method introduce innovative computer technologies aimed at assisting users in recalling forgotten words during conversations. The system addresses a common challenge faced by individuals who may experience memory lapses due to factors such as aging, stress, lack of sleep, or medical conditions like Alzheimer's, aphasia, and dementia. The inability to remember specific words during conversations can lead to stuck communication, causing inconvenience and embarrassment for the speaker.

The disclosed system and method provide an automated solution that enables users to retrieve forgotten words independently, eliminating the need for external assistance from friends or family members. The system utilizes a combination of a conversation computation agent, a language processing system, and an individualized knowledge system. It leverages a large language model, natural language processing tools, and domain knowledge databases to analyze and understand the context of conversations. The individualized knowledge system stores information specific to each user, including words frequently forgotten and contextual details related to those words.

The disclosed system and method include a conversation computation agent capable of offering personalized assistance, considering the user's life experiences, relationships, interests, and communication style. This individualization is particularly beneficial for people facing memory decline due to various factors. A key functionality of disclosed system involves detecting stuck episodes in conversations, analyzing contextual information, and generating hints or suggested words to aid users in overcoming memory lapses. A conversation computation agent promotes a seamless and respectful flow of communication in daily life, contributing to improved social interactions for individuals facing memory challenges.

Another unique and vital element of the presently disclosed system and method is the preservation of kindness, nuanced cultural thoughtfulness, sensibility, and cognizance in moral and civil discourse. In the realm of memory assistance, the disclosed system and method are designed not only to prompt the retrieval of words but to do so with an awareness of the cultural context, emotional sensitivity, and ethical considerations. This ensures that the generated hints and word suggestions are not only accurate but also align with the user's values, promoting respectful and considerate communication even in challenging situations. The disclosed system and method incorporate mechanisms to avoid generating hints that may provoke or offend, contributing to a positive and inclusive conversational experience.

Furthermore, the disclosed system and method incorporate human-like qualities to encourage widespread user acceptance. By humanizing the system, making it relatable and attuned to human values and sensitivities, which encourages users' engagement with and adoption. This approach fosters a user-friendly environment, increasing the likelihood that people will embrace and regularly use the software for their memory assistance needs.

In one general aspect, the present invention relates to a computer system for assisting users to remember words during conversations, that includes a computer memory that can store stuck markers that indicate a user forgets a word in a conversation, wherein the computer memory can store a list of stuck words that the user often forgets during conversations; and one or more computer processors in communication with the computer memory, the one or more computer processors configured to execute a conversation computation agent and a large language model responsive to the conversation computation agent, wherein the conversation computation agent can receive a conversation conducted by the user, the conversation including a stuck episode in which the user forgets a word or a phrase, wherein the large language model can detect the stuck episode in the conversation based on the stuck markers stored in the computer memory, wherein the large language model can generate the word or the phrase forgotten by the user in the stuck episode based on the list of stuck words and the conversation.

Implementations of the system may include one or more of the following. The conversation computation agent can generate one or more hints to the word or the phrase forgotten by the user, wherein the one or more hints or the word or the phrase generated by the conversation computation agent are provided to the user to assist the user to remember the word or the phrase forgotten in the stuck episode of the conversation. The conversation computation agent can receive user responses to the word or the phrase or a hint to the word or the phrase generated by the conversation computation agent, whereas the large language model can generate an improved word or an improved phrase at least in part based on the user responses and the conversation. The computer memory can store contextual information during the user's conversations in association with the stuck words, wherein the large language model can further analyze context around the stuck marker in the conversation at least in part based on the contextual information stored in the computer memory and the list of stuck words to predict the word or the phrase forgotten by the user. The conversation computation agent can receive user responses to the word or the phrase or a hint to the word or the forgotten phrase generated by the conversation computation agent, wherein the large language model can generate an improved word or an improved phrase at least in part based on the user responses and context around the stuck episode in the conversation. The conversation computation agent comprises a hint generator configured to receive the conversation conducted by the user and to generate the word or the phrase forgotten by the user or hints to the word or the phrase. The computer memory can store a hint library containing hints to words or phrases that the user often forgets, wherein the hint generator can generate the hints to the word or the phrase forgotten by the user during the conversation at least in part based on the hints stored in the hint library. The hint generator can produce probabilities of the word or the phrase and associated hints that help the user to remember a forgotten word or forgotten phrases in the conversation, wherein the word or the phrase and associated hints can be selected based on the probabilities. The conversation computation agent can include a multimodal module configured to receive the conversation in one or more forms of voice, images, video, text, or touch. The conversation computation agent can include a sentence formation module configured to produce a sentence including the word or the phrase or hints to the word or the phrase generated by the conversation computation agent, wherein the sentence is output to assist the user to remember the word or the phrase forgotten by the user during the conversation. The conversation computation agent can include a voice generation module configured to generate a voice version of the sentence to assist the user to remember the word or the phrase forgotten during the conversation.

In another general aspect, the present invention relates to a computer system for assisting users to remember words during conversations, that includes a computer memory configured to store stuck markers that indicate a user forgets a word in a conversation, wherein the computer memory can store a list of stuck words that the user often forgets during conversations; and one or more computer processors in communication with the computer memory, the one or more computer processors configured to execute a conversation computation agent and a natural language processing tool responsive to the conversation computation agent, wherein the conversation computation agent can receive a conversation conducted by the user, the conversation comprising a stuck episode in which the user forgets a word or a phrase, wherein the natural language processing tool can detect the stuck episode in the conversation based on the stuck markers stored in the computer memory, wherein the natural language processing tool can generate the word or the phrase forgotten by the user in the stuck episode based on the list of stuck words and the conversation.

Implementations of the system may include one or more of the following. The conversation computation agent can generate one or more hints to the word or the phrase forgotten by the user, wherein the one or more hints or the word or the phrase forgotten by the user are provided to the user to assist the user to remember the word or the phrase forgotten by the user in the stuck episode of the conversation. The conversation computation agent can receive user responses to the word or the phrase or a hint to the word or the phrase generated by the conversation computation agent, whereas the natural language processing tool can generate an improved word or an improved phrase at least in part based on the user responses and the conversation. The computer memory can store contextual information during the user's conversations in association with the stuck words, wherein the natural language processing tool is further configured to analyze context around the stuck episode in the conversation based on the contextual information stored in the computer memory to predict the word or the phrase forgotten by the user in the stuck episode based on the list of stuck words. The conversation computation agent can receive user responses to the word or the phrase or a hint to the word or the phrase generated by the conversation computation agent, wherein the natural language processing tool can generate an improved word or an improved phrase at least in part based on the user responses and context around the stuck episode in the conversation.

In another general aspect, the present invention relates to a computer-implemented method for assisting users to remember words during conversations, that includes training a conversation computation agent by a computer system using a user's conversations to produce and update stuck markers, wherein the stuck markers indicate that a user forgets a word in a conversation, training the conversation computation agent using the user's conversations to produce and update stuck words that are often forgotten by the user during conversations, receiving, by the conversation computation agent, a conversation conducted by the user comprising a stuck episode in which the user forgets a word, detecting a stuck marker in the conversation by the conversation computation agent using LLM and/or NLP tools, and generating the word or a hint to the word forgotten by the user by the conversation computation agent using LLM and/or NLP tools to assist the user to remember the word forgotten in the stuck episode of the conversation.

Implementations of the system may include one or more of the following. The computer-implemented method can further include receiving user responses to the hint or the word generated by the conversation computation agent and updating the stuck markers or the stuck words based on the user responses. The computer-implemented method can further include training the conversation computation agent using the user's conversations to store, in a stuck contextual memory, contextual information during the user's conversations in association with the stuck words; extracting context around the stuck marker in the conversation by the conversation computation agent using LLM and/or NLP tools; and analyzing the context around the stuck marker in the conversation by the conversation computation agent using LLM and/or NLP tools in communication with the stuck word list and the contextual memory, wherein the hint or the stuck word can be generated by the conversation computation agent at least in part based on the stuck word list and the contextual memory. The computer-implemented method can further include receiving user responses to the hint or the word generated by the conversation computation agent; and updating the stuck markers or the contextual memory based on the user responses.

### BRIEF DESCRIPTION OF DRAWINGS

FIG. 1 is a system diagram of an automated computer system for assisting speakers to remember words in conversations in accordance with some embodiments of the present invention.

FIG. 2 is a detailed block diagram for a conversation computation agent compatible with the automated system in FIG. 1 in accordance with some embodiments of the present invention.

FIG. 3 is a system flow diagram illustrating the training of a conversation computation agent in accordance with some embodiments of the present invention.

FIG. 4 is a flowchart for setting up and using an automated system to assist speakers to remember words in conversations in accordance with some embodiments of the present invention.

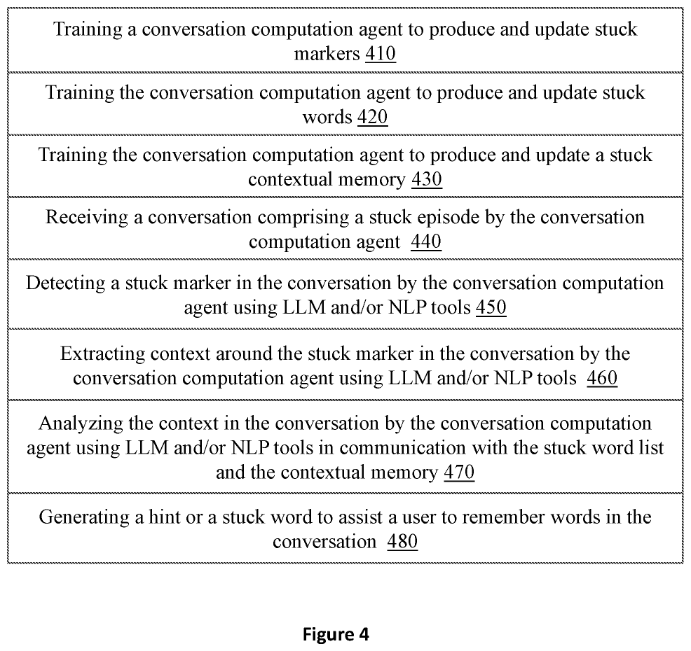

### DETAILED DESCRIPTION OF THE INVENTION

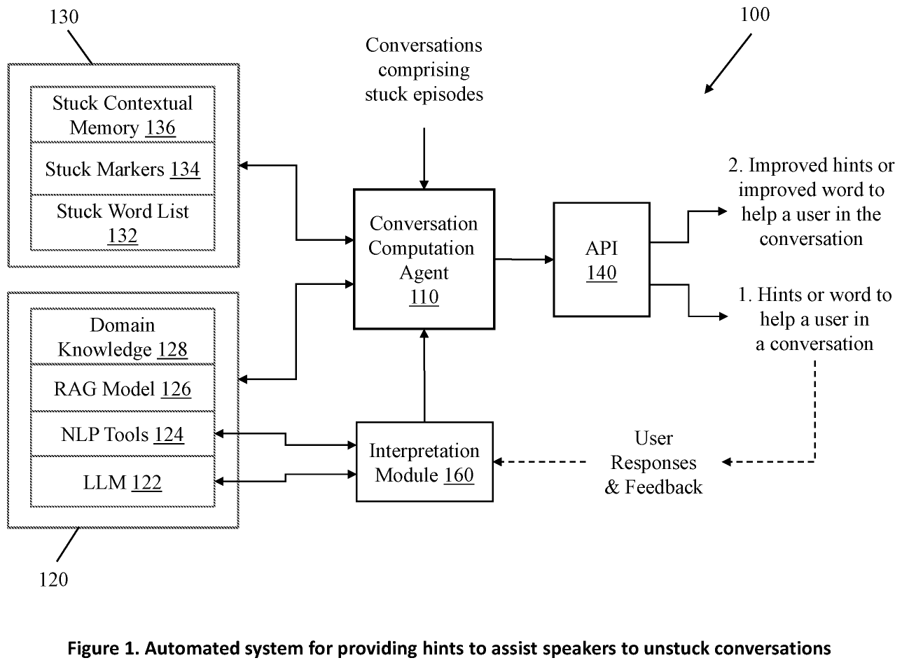

FIG. 1 shows a computer system 100 for assisting speakers to remember words in conversations. The computer system 100 includes one or more computer processors and computer memory. The computer system 100 includes a conversation computation agent 110, a language processing system 120, and an application programming interface (API) 140, which are installed and executed on the one or more computer processors, and an individualized knowledge system 130 stored in the computer memory. The language processing system 120 can include a large language model (LLM) 122 and/or one or more natural language processing (NLP) tools 124, a retrieval-augmented generation (RAG) module 126, and a domain knowledge database 128. The individualized knowledge system 130 can include a stuck word list 132, stuck markers 134, and stuck contextual memory 136.

In the present disclosure, the word “stuck” is used to describe the state of a conversation in which a speaker forgets certain information, normally a word or a phrase, which halts or inhibits the natural flow of the conversation.

The LLM 122 is a deep learning algorithm that can perform a variety of natural language processing tasks. The LLM 122 uses transformer models trained using large datasets. The NLP tools 124 uses machine learning to analyze text to uncover meaningful information and insight. In comparison to the LLM 122, the NLP tools 124 require less computation and data resources, which typically have faster processing rate and are less costly to operate. The RAG model 126 retrieves facts from an external knowledge base to ground the LLM 122 and the NLP tools 124 on the most accurate, up-to-date information and to give users insight into LLMs' generative process. The domain knowledge database 128 can include information related to memories, speech therapy, brain wellness, cognitive disorders, and aging. The information stored in the domain knowledge database 128 can include the symptom patterns and remedy methods for the memory loss of words, the retrieval of words, and the verbalization of the words.

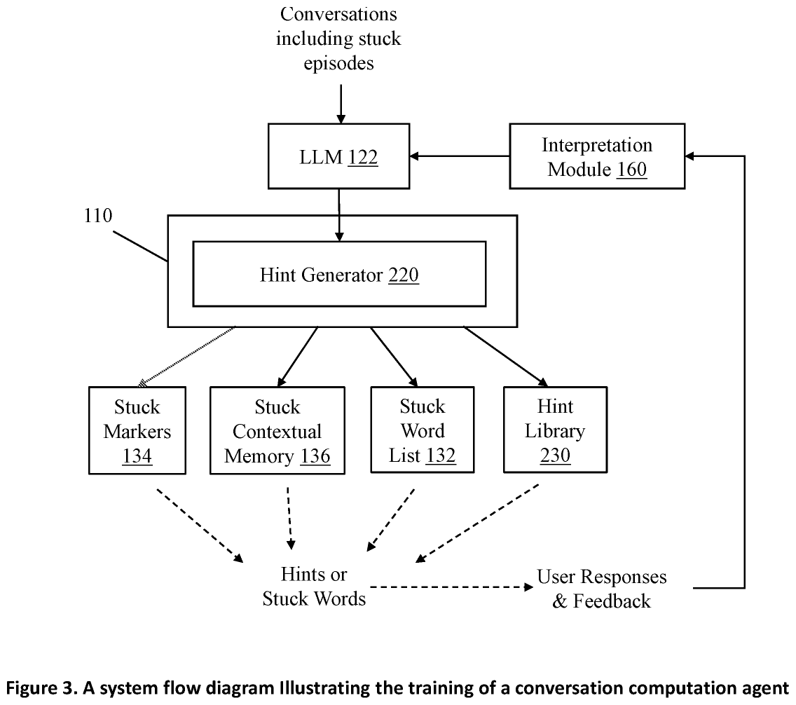

The individualized knowledge system 130 stores information specific to a user: words that the user often forgets during conversation and specific information about the episodes of interruptions during that user's conversations. The stuck word list 132 includes words that a user (or patient) has difficulty remembering or saying during conversations. The stuck word list 132 can include names of people including family members, friends, and caretakers etc., companies, places, daily activities, interests, hobbies, and life experiences, etc. The stuck word list 132 can be built up during training sessions and during the use sessions based on feedback from the particular user, as discussed below in connection with FIG. 3.

Stuck markers 134 are signals that indicate that a user forgets a word and is stuck in a conversation. Stuck markers can include a longer-than-average pause indicating hesitation, verbal indicators such as “uh”, “that”, analogies of the forgotten word such as “something like coffee”, “it is similar to a market”, meaning of the forgotten word such as “it is a type of a drink”, phonetic cues of the forgotten word such as “it sounds like . . . ”, spelling cues such as “it starts with a letter ‘c’” and “the word starts with a ‘b’”, text cues that a user types or wrote on a device, and gestures of a user that illustrate or reveal the forgotten word which is captured by the camera of a device.

Stuck contextual memory 136 stores contextual information during the user's conversations in association with the stuck words in the stuck word list 132. For example, when a user talks about a gas station, a repetitive pattern is discovered by the computer system 100 that the user often forgets the name of a gas station. The contextual information of pumping gas and gas station can be stored in association with the name of a gas station. A person's life experience, upbringing, education, occupation, interest, hobbies, or past residence can be stored in association with the name of a place.

The individualized knowledge system 130 can also store other personal data such as important people in the user's life, user's occupations, places of residence, age, hobbies, and notable events in life, and other person-specific information.

During a user session, the computer system 100 records a conversation by a user and inputs the recorded conversation to the conversation computation agent 110. The conversation may include one or more episodes in which the user forgets a word and the conversation becomes stuck, that is, “stuck episodes.” The conversation computation agent 110 employs the LLM 122 and the NLP tools 124 based on the stuck markers 134 in the individualized knowledge system 130 to detect these stuck episodes. Once these stuck episodes are detected, the conversation computation agent 110 enlists the LLM 122 and/or the NLP tools 124 to analyze the context of the conversation before as well as after the point where the conversation becomes stuck. The LLM 122 and/or the NLP tools 124 further analyze the context of the conversation around the stuck episode using the inputs from the stuck word list 132 and the stuck contextual memory 136. The LLM 122 and/or the NLP tools 124 are able to reveal underlying relationships and patterns to predict the word that is forgotten by the user in this stuck episode.

The conversation computation agent 110 generates one or more sentences that convey the suggested forgotten words, or hints to the forgotten words and fit the conversation conducted by the user. In some situations, hints to the forgotten words rather than an answer to the word itself are preferred, which may help the user memory exercise and build associative memories to the forgotten word. The formation of the one or more sentences can be assisted by a language chaining model which can be part of the conversation computation agent 110 or the language processing system 120. The language chaining model formulates the sentences based on the hints to the forgotten words produced as well as the context of the conversation. The API 140 receives the one or more sentences from the conversation computation agent 110 and outputs the one or more sentences to the user (the first output in FIG. 1). The output can be in different forms such as audio playing of the sentence, text display of the sentences, the predicted word, or the hints.

In some embodiments, still referring to FIG. 1, the computer system 100 can include an interpretation module 160 that receives user's responses and feedback to the first hints or the first predicted answer to the forgotten word. If the conversation continues smoothly overcoming the forgotten word (i.e., the conversation is stuck), interpretation module 160 validates the last computation and predictions of the LLM 122 and/or the NLP tools 124, the individualized knowledge system 130. If the hints and the predicted answer to the forgotten word do not enable the user to continue the conversation, the user may be puzzled and raise more questions, and may provide additional information associated with the forgotten word or phrase.

In some embodiments, the user's feedback and response are received by an interpretation module 160, in which the feedback information is analyzed by the conversation computation agent 110 with the assistance with the LLM 122 and/or NLP tools 124. In some embodiments, the interpretation module 160 (FIG. 1) can be part of the conversation computation agent 110. Enhanced prompts can be obtained for the LLM 122 and/or NLP tools 124 to assist the conversation computation agent 110 to further analyze the context around the stuck episode in the conversation similar to the process described above. The conversation computation agent 110 provides improved hints or an improved answer (the second output in FIG. 1) to the forgotten word or phrase to the user via the API 140. The same steps in the feedback loop can be repeated one or multiple times until the user correctly expresses herself and continues with the conversation.

In some embodiments, when the suggested answer to the word or phrase forgotten by the user is validated by the user's feedback and response, the suggested word or phrase is automatically compared to the words in the stuck word list 132. The suggested word or phrase can be added to the stuck word list 132 if they are not already stored therein.

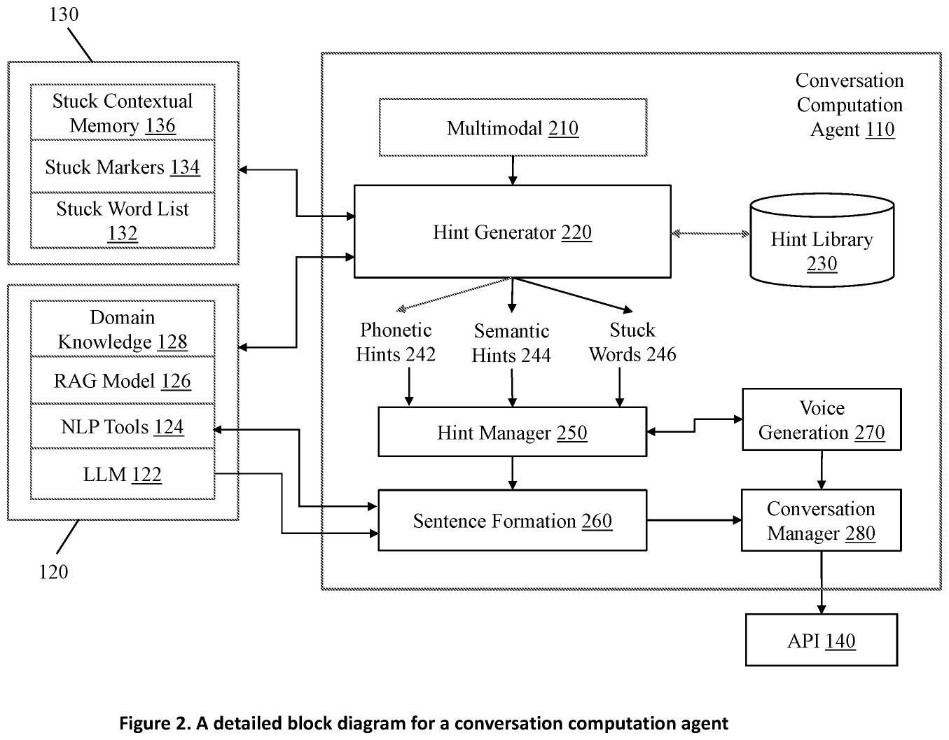

Referring to FIG. 2, the conversation computation agent 110 includes a multimodal module 210, a hint generator 220, a hint library 230, a hint manager 250, a sentence formation module 260, a voice generation module 270, and a conversation manager module 280. In some embodiments, the interpretation module 160 (FIG. 1) can be part of the conversation computation agent 110.

The multimodal module 210 can receive different forms of inputs from a user during a conversation such as voice, images, video, text, touch, etc., and convert them into digital information to input to the hint generator 220. The hint library 230 stores hints that have been developed by machine learning based on a user's historic conversations and user's personal data such as life experiences, daily routine, occupation, hobbies, etc. The hints stored in the hint library 230 can be customized to individual users but can also include cues useful for all users. In some embodiments, the hint library 230 can be stored outside of the conversation computation agent 110 and can be stored in the individualized knowledge system 130.

The hint generator 220 is the engine of the conversation computation agent 110: it synthesizes computation resources and stored knowledge to analyze information received from a user conversation, and outputs different types of hints specific to the user's conversation. The hint generator 220 can retrieve information from the stuck word list 132, the stuck markers 134, and the stuck contextual memory 136 in the individualized knowledge system 130. The hint generator 220 requests the LLM 122 and/or the NLP tools 124 to analyze the user conversation based on the stuck markers 134 to detect stuck episodes during the user's conversation. Once these stuck episodes are detected, the hint generator 220 requests the LLM 122 and/or the NLP tools 124 to analyze the context of the conversation before and after the point where the conversation becomes stuck. The LLM 122 and/or the NLP tools 124 further analyze the context of the conversation around the stuck episode using the inputs from the stuck word list 132 and the stuck contextual memory 136. The LLM 122 and/or the NLP tools 124 can reveal underlying relationships and patterns to predict the word that is forgotten by the user in this stuck episode. Based on the outputs of the LLM 122 and/or the NLP tools 124 and the hints stored in the hint library 230, the hint generator 220 can output different types of hints such as phonetic hints 242 (e.g., “the word sounds like potato”, “it starts with a “k” sound) and semantic hints 244 (“it is a type of a drink”, “it is a hot drink one drinks in the morning”). Other types of hints can include analogies, the circumstances where this word was used or forgotten by the user previously, a picture or animation to provide cues to the forgotten word. The hint generator 220 can also output the predicted stuck word 246 or phrases directly.

In some embodiments, the hint generator 220 enlist the LLM 122 and/or the NLP tools 124 to calculate the probabilities of the predicted stuck word 246 being correct, and the probabilities that the phonetic hints 242 and the semantic hints 244 can help the speaker or user to recall the forgotten word during the conversation. These probabilities of the word or the phrase and associated hints indicate the success rates that they will help the user to carry out the conversation. The calculations of these probabilities are in part based on the stuck word list 132, the stuck markers 134, and the stuck contextual memory 136 with higher probabilities are given to pre-stored stuck words and pre-stored contextual associations.

Referring to FIGS. 1 and 2, an important feature of the presently disclosed system is that the hint generator 220 can provide a personalized, targeted memory cue to the user. The hint generator 220 accomplishes this personalized information in the RAG model 126 and the domain knowledge database 128. Using a user's favorite sports team as an example, the Golden State Warriors. This includes players' names, statistics, memorable games, championship seasons, fan rituals, etc. When the user is discussing the Warriors but forgets a player's name, like Klay Thompson, the conversation computation agent 110 passes the conversational context to the RAG model 126, which searches the knowledge graph in the domain knowledge database 128 and retrieves helpful, relevant hints about Klay to jog the user's memory. For example, if the user says, “I can't remember the name of that Warriors guard who is an incredible 3-point shooter” the model could respond “Are you thinking of #11, the Splash Brother nicknamed ‘Game 6 Klay’ Thompson?” By focusing the hints on pertinent facts around Klay's position, jersey number, shooting ability and playoff performances, the hint generator 220 can provide a personalized, targeted memory cue to the user. The knowledge graph in the RAG model 126 limits hints to verifiable facts about the Warriors, removing the risk of harmful fabrication. Additionally, training the RAG model 126 directly on this domain-specific graph allows retrieving helpful hints matched to the user's interests and conversation style.

In contrast to traditional generative models that may hallucinate ungrounded outputs, the RAG model 126 is restricted to surfacing hint text grounded in the user's personalized knowledge graph. This prevents manufacturing of false, illegal, or insensitive hints that could be generated by AI systems without proper verification. Additionally, the RAG model 126 has been fine-tuned with techniques such as self-consistency to increase output veracity and self-talk to reduce toxic language. Human-in-the-loop processes allow users to verify hint accuracy and provide feedback to further improve hint quality in an iterative, trustworthy process. In this way, the RAG model 126 enables the system 100 to dynamically serve thoughtful, truthful personalized hints to match each user's context and history. The hybrid retrieval and generation approach can avoid harmful AI behaviors while assisting users in overcoming inconvenient memory lapses.

An important characteristic of the hints generator 220 extends beyond the technical aspects of assisting users in recalling forgotten words. The hint generator 220 incorporates a unique and vital element—the preservation of kindness, nuanced cultural thoughtfulness, sensibility, and cognizance in moral and civil discourse. In the realm of memory assistance, the hint generator 220 and the domain knowledge 128 are designed not only to prompt the retrieval of words but to do so with an awareness of the cultural context, emotional sensitivity, and ethical considerations. This ensures that the generated hints are not only accurate but also align with the user's values, promoting respectful and considerate communication even in challenging situations. The hint generator 220 and the domain knowledge 128 incorporate mechanisms to avoid generating hints that may provoke or offend, contributing to a positive and inclusive conversational experience. The computer system 100 and the

Moreover, the hint generator 220 and the domain knowledge 128 are also designed to possess thoughtfulness with cultural nuance. Delicate consideration of cultural nuances is integrated into the system, ensuring a thoughtful approach that takes into account the intricacies and subtleties of diverse cultural contexts. This feature goes beyond mere accuracy, emphasizing a respectful understanding of the cultural background of users, thereby enhancing the overall effectiveness and appropriateness of the generated hints.

The computer system 100 and the conversation computation agent 110 incorporate human-like qualities to encourage widespread user acceptance. By humanizing the system, making it relatable and attuned to human values and sensitivities, users are more inclined to engage with and trust the disclosed system and methods. This described approach fosters a user-friendly environment, increasing the likelihood that people will embrace and regularly use the software for their memory assistance needs.

Referring to FIG. 2, the hint manager 250 receives the different types of hints such as the phonetic hints 242 and the semantic hints 244, and the predicted stuck word 246. The hint manager 250 requests the sentence formation module 260 to model and complete sentences to convey the hints to the user. In some embodiments, the hint manager 250 can select one of the predicted stuck word 246, the phonetic hints 242, or the semantic hints 244 based on the above described probabilities of success to send to the sentence formation module 260 and the voice generation module 270.

The sentence formation module 260 generates one or more sentences that convey the suggested forgotten words, or hints to the forgotten words and integrate naturally into the conversation conducted by the user. In some situations, hints to the forgotten words rather than an answer to the word itself are preferred, which may help the user memory exercise and build associative memories to the forgotten word. The formation of the one or more sentences can be assisted by a language chaining model which can be part of the sentence formation module 260 or stored in the language processing system 120. The language chaining model formulates the sentences based on the hints to the forgotten words produced as well as the context of the conversation.

The API 140 receives the one or more sentences from the conversation computation agent 110 and outputs the one or more sentences to the user. The output can be in different forms such as audio playing of the sentence, text display of the sentences, the predicted word, or the hints.

The hint manager 250 requests the voice generation module 270 to generate voice form of the sentences. Alternatively, the sentence comprising the hints can also be displayed or played in animation or videos. The conversation manager module 280 outputs the sentence comprising the hints. The API 140 presents the sentence to the user to help the user to recall and speak the previously forgotten word or phrase to continue or finish the conversation.

The pre-stored memory in individualized knowledge system 130 (FIGS. 1 and 2) and the hint library 230 (FIG. 2) can be trained by machine learning using a user's conversations. In some embodiments, referring to FIG. 3, a high-level flow for the training the pre-stored memory can include the following. A user's conversations including stuck episodes is input to the LLM 122 and/or the NLP tools 124 under the control of the hint generator 220 in the conversation computation agent 110. The LLM 122 and/or the NLP tools 124 analyze the conversation as described above: identifying stuck episodes, analyzing contextual information, and making predictions of the stuck words. The conversation computation agent 110 outputs different types of hints such as phonetic hints 242 and semantic hints 244, the predicted stuck word 246, The generated hints or stuck words are formulated in sentences and presented to the user.

In some embodiments, the user's response and feedback are received by the interpretation module 160. If the conversation continues smoothly overcoming the forgotten word (i.e., the conversation is stuck), interpretation module 160 validates the stuck markers, the contextual information, and the predicted stuck words produced by the LLM 122 and/or the NLP tools 124. The hint generator 220 can update the hints and stuck words in the stuck word list 132 and the hint library 230, respectively. The hint generator 220 can also update the stuck markers and contextual information in the stuck markers 134 and the stuck contextual memory 136, respectively. It should be noted that pre-stored memory in individualized knowledge system 130 (FIGS. 1 and 2) and the hint library 230 (FIG. 2) can be continuously updated and improved beyond training and in the use sessions.

In some embodiments, a computer system for assisting speakers to remember words in conversations can include one or more of the following steps. As described above in relation to FIG. 3, a conversation computation agent is trained using user conversations to produce and update stuck markers (step 410), which can be stored in an individualized knowledge system. The conversation computation agent is trained using user conversations to produce and update stuck words (step 420), which can be stored in an individualized knowledge system. The conversation computation agent is also trained using user conversations to produce and update stuck contextual memory (step 430), which can be stored in an individualized knowledge system. The training in steps 410-430 can utilize LLMs and/or NLP tools to generate hints and/or answers to the predicted stuck words. The training updates the individualized knowledge system based on user responses and feedback.

In use sessions, a conversation conducted by the user comprising a stuck episode is received by the computer system and the conversation computation agent therein (step 440). A stuck marker in the conversation is detected by the conversation computation agent with the processing assistance of LLMs and/or NLP tools and pre-stored stuck markers (step 450). Contextual information around the stuck marker in the conversation is extracted by the conversation computation agent with the processing assistance of LLMs and/or NLP tools (step 460). The contextual information is analyzed by the conversation computation agent with the processing assistance of LLM and/or NLP tools in communication with the stuck word list and the contextual memory (step 470). Hints or stuck words to the forgotten word at the stuck episode are generated by the conversation computation agent using LLM and/or NLP tools to assist a user to remember words in the conversation (step 480). The hint or the stuck word is generated by the conversation computation agent at least in part based on the stuck word list and the contextual memory.

Only a few examples and implementations are described. Other implementations, variations, modifications and enhancements to the described examples and implementations may be made without deviating from the spirit of the present invention. It should be noted that the presently disclosed computer system for providing hints to assist speakers to remember words in conversations is not limited to the specific examples described above. The presently disclosed computer system can be implemented on a mobile application, a cloud system, a local computer network, and/or a combination thereof. The presently disclosed computer system is compatible with different types of large language models such as foundation models, domain-specific models, zero-shot models, and single-modal or multimodal models. The presently disclosed computer system can also employ different forms of natural language processing tools such as sentiment analysis, named entity recognition, summarization, topic modeling, text classification, keyword extraction, and lemmatization and stemming. The large language models and the natural language processing tools can be implemented on a computer network, a cloud system, or on one or more user devices.

1. A computer system for assisting users to remember words during conversations, comprising:
a computer memory configured to store stuck markers that indicate a user forgets a word in a conversation, wherein the computer memory is configured to store a list of stuck words that the user often forgets during conversations; and
one or more computer processors in communication with the computer memory, the one or more computer processors configured to execute a conversation computation agent and a large language model responsive to the conversation computation agent,
wherein the conversation computation agent is configured to receive a conversation conducted by the user, the conversation comprising a stuck episode in which the user forgets a word or a phrase,
wherein the large language model is configured to detect the stuck episode in the conversation based on the stuck markers stored in the computer memory,
wherein the large language model is configured to generate the word or the phrase forgotten by the user in the stuck episode based on the list of stuck words and the conversation.

2. The computer system of claim 1, wherein the conversation computation agent is configured to generate one or more hints to the word or the phrase forgotten by the user, wherein the one or more hints or the word or the phrase generated by the conversation computation agent are provided to the user to assist the user to remember the word or the phrase forgotten in the stuck episode of the conversation.

3. The computer system of claim 1, wherein the conversation computation agent is configured to receive user responses to the word or the phrase or a hint to the word or the phrase generated by the conversation computation agent, wherein the large language model is configured to generate an improved word or an improved phrase at least in part based on the user responses and the conversation.

4. The computer system of claim 1, wherein the computer memory is configured to store contextual information during the user's conversations in association with the stuck words, wherein the large language model is further configured to analyze context around the stuck marker in the conversation at least in part based on the contextual information stored in the computer memory and the list of stuck words to predict the word or the phrase forgotten by the user.

5. The computer system of claim 4, wherein the conversation computation agent is configured to receive user responses to the word or the phrase or a hint to the word or the forgotten phrase generated by the conversation computation agent, wherein the large language model is configured to generate an improved word or an improved phrase at least in part based on the user responses and context around the stuck episode in the conversation.

6. The computer system of claim 1, wherein the conversation computation agent comprises a hint generator configured to receive the conversation conducted by the user and to generate the word or the phrase forgotten by the user or hints to the word or the phrase.

7. The computer system of claim 6, wherein the computer memory is configured to store a hint library comprising hints to words or phrases that the user often forgets, wherein the hint generator is configured to generate the hints to the word or the phrase forgotten by the user during the conversation at least in part based on the hints stored in the hint library.

8. The computer system of claim 1, wherein the hint generator is configured to produce probabilities of the word or the phrase and associated hints that help the user to remember a forgotten word or forgotten phrases in the conversation, wherein the word or the phrase and associated hints are selected based on the probabilities.

9. The computer system of claim 1, wherein the conversation computation agent comprises a multimodal module configured to receive the conversation in one or more forms of voice, images, video, text, or touch.

10. The computer system of claim 1, wherein the conversation computation agent comprises a sentence formation module configured to produce a sentence comprising the word or the phrase or hints to the word or the phrase generated by the conversation computation agent, wherein the sentence is output to assist the user to remember the word or the phrase forgotten by the user during the conversation.

11. The computer system of claim 10, wherein the conversation computation agent comprises a voice generation module configured to generate a voice version of the sentence to assist the user to remember the word or the phrase forgotten during the conversation.

12. A computer system for assisting users to remember words during conversations, comprising:
a computer memory configured to store stuck markers that indicate a user forgets a word in a conversation, wherein the computer memory is configured to store a list of stuck words that the user often forgets during conversations; and
one or more computer processors in communication with the computer memory, the one or more computer processors configured to execute a conversation computation agent and a natural language processing tool responsive to the conversation computation agent,
wherein the conversation computation agent is configured to receive a conversation conducted by the user, the conversation comprising a stuck episode in which the user forgets a word or a phrase,
wherein the natural language processing tool is configured to detect the stuck episode in the conversation based on the stuck markers stored in the computer memory,
wherein the natural language processing tool is configured to generate the word or the phrase forgotten by the user in the stuck episode based on the list of stuck words and the conversation.

13. The computer system of claim 12, wherein the conversation computation agent is configured to generate one or more hints to the word or the phrase forgotten by the user, wherein the one or more hints or the word or the phrase forgotten by the user are provided to the user to assist the user to remember the word or the phrase forgotten by the user in the stuck episode of the conversation.

14. The computer system of claim 12, wherein the conversation computation agent is configured to receive user responses to the word or the phrase or a hint to the word or the phrase generated by the conversation computation agent, wherein the natural language processing tool is configured to generate an improved word or an improved phrase at least in part based on the user responses and the conversation.

15. The computer system of claim 12, wherein the computer memory is configured to store contextual information during the user's conversations in association with the stuck words, wherein the natural language processing tool is further configured to analyze context around the stuck episode in the conversation based on the contextual information stored in the computer memory to predict the word or the phrase forgotten by the user in the stuck episode based on the list of stuck words.

16. The computer system of claim 15, wherein the conversation computation agent is configured to receive user responses to the word or the phrase or a hint to the word or the phrase generated by the conversation computation agent, wherein the natural language processing tool is configured to generate an improved word or an improved phrase at least in part based on the user responses and context around the stuck episode in the conversation.

17. A computer-implemented method for assisting users to remember words during conversations, comprising,
training a conversation computation agent by a computer system using a user's conversations to produce and update stuck markers, wherein the stuck markers indicate that a user forgets a word in a conversation;
training the conversation computation agent using the user's conversations to produce and update stuck words that are often forgotten by the user during conversations;
receiving, by the conversation computation agent, a conversation conducted by the user comprising a stuck episode in which the user forgets a word;
detecting a stuck marker in the conversation by the conversation computation agent using LLM and/or NLP tools; and
generating the word or a hint to the word forgotten by the user by the conversation computation agent using LLM and/or NLP tools to assist the user to remember the word forgotten in the stuck episode of the conversation.

18. The computer-implemented method of claim 17, further comprising:
receiving user responses to the hint or the word generated by the conversation computation agent; and
updating the stuck markers or the stuck words based on the user responses.

19. The computer-implemented method of claim 17, further comprising:
training the conversation computation agent using the user's conversations to store, in a stuck contextual memory, contextual information during the user's conversations in association with the stuck words;
extracting context around the stuck marker in the conversation by the conversation computation agent using LLM and/or NLP tools; and
analyzing the context around the stuck marker in the conversation by the conversation computation agent using LLM and/or NLP tools in communication with the stuck word list and the contextual memory,
wherein the hint or the stuck word is generated by the conversation computation agent at least in part based on the stuck word list and the contextual memory.

20. The computer-implemented method of claim 19, further comprising:
receiving user responses to the hint or the word generated by the conversation computation agent; and
updating the stuck markers or the contextual memory based on the user responses.
